(19) United States
(12) Patent Application Publication
(10) Pub. No.: US 2024/0045441 A1
(43) Pub. Date: Feb. 8, 2024

(54) COMPUTER IMPLEMENTED METHOD FOR THE INDEXING OF TWO DIMENSIONAL SPACES, ROBOT LOCATION SYSTEM, COMPUTER PROGRAM, AND COMPUTER-READABLE DATA CARRIER THEREOF

(71) Applicant: UNIVERSIDADE DO ALGARVE, Faro (PT)

(72) Inventors: Jânio Miguel EVANGELISTA FERREIRA MONTEIRO, Faro (PT); André DA SILVA PEDRO, São Brás de Alportel (PT); António João FREITAS GOMES DA SILVA, Faro (PT)

(21) Appl. No.: 18/266,780

(22) PCT Filed: Dec. 9, 2021
(86) PCT No.: PCT/IB2021/061492

§ 371 Date: Jun. 12, 2023

(30) Foreign Application Priority Data
Dec. 14, 2020 (PT) 116940

(51) Int. Cl. G05D 1/02

(52) U.S. Cl. CPC G05D 1/0274; G05D 1/027; G05D 1/0246

(57) ABSTRACT

The invention comprises a computer implemented method for the indexing of one and two-dimensional spaces using Gray code sequences, wherein the said method comprises a spatial indexing based in a triangular coordinate system, wherein the triangles are subdivided forming a plurality of sub-triangles, which are further encoded, resulting in a plurality of encoded layers; and a generation of a hexagonal coordinate system, which can be used to define the location of an autonomous robot.

The invention meets the requirements for the spatial encoding, since it allows that two adjacent locations have a high degree of similarity, it is immune to transition errors when moving between adjacent locations, and allows the logical aggregation of neighbor locations to enable the spatial indexing of assets and objects that might span over several spatial units.

### TECHNICAL FIELD

The present disclosure relates to the field of computer technology, in particular to an indexing method for one and two dimensional spaces, based in a Gray encoding, that, among several applications, allow the encoding of a robot's location.

### BACKGROUND ART

In the brains of humans and mammals, the formation of episodic memories results from the association between objects, space and time. Both, the Hippocampus and the Entorhinal Cortex have shown to play an essential role in the formation of these memories. The Hippocampus, may be considered as an indexer of the pattern of neocortical activity produced by an episode, while the Entorhinal Cortex, is characterized as performing time and space integration, conveying that information to the Hippocampus, in the form of Grid Cells. Although these Grid Cells are biological based, non-biological Grid Cells are used in discrete global grid systems that currently support the indexing of geospatial data across the globe, allowing a more adequate partitioning of the earth into logical structures that take into account the heterogeneity of the scales of geospatial data. The reasons that led to the definition of these grid systems at macro levels, may have led to the creation of similar structures inside our brains.

Human and non-human brains are somehow able to associate distinct inputs from different senses and to predict the associated sequence of values. In these brains numerous inputs from the visual, olfactory, auditory, taste, somatosensory, and self-motion senses are somehow combined to form a coherent understanding of our surroundings.

What is more interesting in this process, is that it is done without labeling these inputs, i.e. somehow these brains are able to identify the uniqueness of each event, both in a time instant basis, and in a sequence of events, by a process that we call learning. In fact, we can state that, the identification of a condition and the association of inputs requires at least two different processes. In some cases, the identification of a pattern does not require the knowledge of a previous sequence of events, as it happens when we recognize a person by its face. In other cases, we are able to associate inputs that do not necessarily happen at the same time. In music for instance, the identification of sequences requires correlating the most recent notes with the previous ones, that we heard before. This requires holding a state, and a notion of what happened previously.

As we move to explore an unknown space, the coherent understanding of that space results from the fusion of the senses and the visual cues that we find in each location, with a notion of a sequence that wires together these different locations. That wiring results from our own actions and movements across that space. So, instead of having a set of uncorrelated senses and images, these cues are combined, to allow the mapping of the space where we move. But how is this done?.

Inside the brain of humans and other mammals there are two hippocampi, each one at each hemisphere, situated on the temporal lobe areas. The main functions of these elements are related to the declarative memory (Gupta & Cohen, 2002), emotional control (Zhu et al., 2019), spatial navigation (Fyhn et al. 2004; Hafting et al. 2005; Hargreaves et al. 2005; Quirk et al. 1992) and episodic memory (Eichenbaum, 2000). The hippocampus is the place where many of our sensory and self-motion senses (Lopez Ruiz et al., 2015) are associated, and thus its structure has been the focus of many studies. These hippocampi receive information that comes from many sensorial systems (visual, olfactory, auditory, taste, somatosensory, self-motion) through the entorhinal cortex (EC) and then projects that information to the neocortical regions and back to the EC.

In brains, sensory inputs pass through the thalamus, the neocortex association areas and perirhinal cortices (Kealy & Commins, 2011) before reaching the entorhinal cortex. Sensory inputs start by being converted into spiking neural representations by the sensory receptors and in the thalamus, which are then conveyed to the neocortex by neural circuits. The conversion into spiking neural representations, can be done using a set of neurons, each one with a specific neuron tuning curve, as claimed by the neuron engineering framework (Eliasmith & Anderson, 2003). In humans, the sensory information is received by layer IV of the neocortex, that then distributes it to other layers, for subsequent processing and storage (Noback C R, Strominger N L, Demarest R J, 2005). Finally, the preprocessed multimodal information reaches the hippocampus through the entorhinal cortex (O'Reilly et al., 2014).

Several models have tried to describe the behavior of our brain, based on the hippocampus. In the hippocampal memory index theory for instance (Teyler & Rudy, 2007) the hippocampus is considered to be able to capture information about neocortical activity generated by the individual features of episodes. Using that information, this model assumes that the hippocampus can then generate an index to the pattern of neocortical activity produced by an episode, projecting it back to these neocortical regions. Thus, the theory assumes that the features that make up a particular episode can establish a memory trace that activates patterns of neocortical activity. So, when a subset of a pattern is received by the neocortex, the projections from that input pattern can activate the connected neurons in the hippocampus that represent the original experience. The identification of that pattern by the hippocampus is then projected back to the neocortex, activating the entire experience. Consequently, if a partial cue is able to activate the index, the associated neocortical patterns are activated, and with it the memory of the episode is retrieved.

So, the hippocampus can be considered an indexer of the information that we gather through our senses. In spatial navigation, the indexing of visual, auditory and/or tactile cues, among others, requires at least two main variables. These are the notion of “where I am” and the notion of “what is my head direction”. This same principle can be applied to a robot that navigates in a certain space and captures information as it moves. In fact, hippocampal based algorithms for Simultaneous Localization and Mapping (SLAM), like RatSLAM (Milford et al., 2004) and NeuroSLAM (Yu et al., 2019), have been created to allow robots to represent and create a map of an environment. The coherent understanding of the information gathered in that process requires an indexing method of the captured information.

Four main properties are required by such indexing method. These are repeatability, similarity, continuity, and scalability. By repeatability, we mean that, when the robot gets back to a certain place, after any walk through the environment, the encoding of the location should always translate the same place. In terms of similarity, the indexing method should assure that the distance between two short-distanced locations have a high degree of similarity. In terms of continuity, it should allow that two adjacent code words should change by a minimum quantity. Finally, in terms of scalability the encoding should assure the coverage of any area, with any arbitrary size and precision.

Rectangular coordinate systems are the most commonly used solution for spatial indexing. In some cases however, other solutions have been considered that show important advantages. Hexagonal coordinate systems, in particular, enable a more consistent connectivity of neighbors. In fact, in a rectangular coordinate system, the distance between neighboring coordinates differ according to whether the neighbor is directly adjacent (i.e., in an edge) or in diagonal (i.e., at a vertex). Under the hex-agonal coordinate system, all neighbors are equidistant. Also, since hexagons are rounder than squares, the dispersion of the distances between the central point and all the points within the space of the hexagon is lower than in a rectangular coordinate system (Hales, 2001). So, when partitioning a two-dimensional space using a hexagonal lattice, the center of each hexagon is a higher precision indexer of the points that are inside that area.

The advantages behind hexagonal grids, when compared with rectangular grids, have led to its recent utilization in the indexing of spatial data. However, a model that approximates the human created indexing methods used in geospatial data with the indexing method that our brains use to guide us in two-dimensional spaces has until now been lacking.

In 2005, a study performed at the University of Oslo (Hafting et al., 2005) concluded that the dorsocaudal Medial Entorhinal Cortex (dMEC) of rats contains an organized neural map of the spatial environment. The key unit of that map was called the ‘Grid Cell’, because the authors have found that the firing field of these principal neurons formed a grid of regularly tessellating triangles, spanning through the whole of the rat's enclosure. After measuring the separation of the peaks using an auto correlogram, they verified that the central peak of the auto correlogram was surrounded by six equidistant peaks forming the vertices of a regular hexagon. They also verified that the pattern was regular across the entire field. The angular separation of the vertices of the inner hexagon was in multiples of 60 degrees, as expected when equilateral triangles are used.

Other studies have shown that while neurons of the Lateral Entorhinal Cortex (LEC) exhibit little spatial selectivity, neurons of the MEC exhibit multiple place fields, arranged in a hexagonal pattern (Hargreaves et al., 2005). In (Brun et al., 2008) it was also verified that place fields and the spacing between these fields increases from the dorso-lateral to the ventro-medial MEC suggesting a multilevel, and multilayer scalability.

Later studies have found that besides grid cells, other cells called Speed Cells were also found in the MEC of rats (Kropff et al., 2015). In these cells, the speed of movement was found to be represented by a firing rate that varies linearly with the animal's velocity. That mechanism was found to be independent of the visual input and was consistent with the idea that it could be translated from proprioceptive or motor-efference information.

Besides grid and speed cells, other types of neurons were already known to increase their firing rates when the animal's head points to a specific direction. These so-called head direction (HD) cells (Taube et al., 1990) can be found in the Entorhinal Cortex (EC) and in other brain regions.

The question that arises from these cells is how they can be combined to build a coherent map of a space. As stated, spatial arrangements of grid cells are consistent with both triangular and hexagonal arrangements. In fact, a hexagon can be decomposed into triangles, however an hexagon is not rep-tiled (or reptiled), in the sense that it cannot be dissected into smaller hexagons. This means that, apparently, we cannot build a multilayer encoding of a space using rep-tiled hexagons with different sizes. However, the present invention shows that such issue can be overcome.

### The Hippocampus and the Entorhinal Cortex

The formation of episodic memories results from the association between objects, space and time (Tulving, 2002). Both, the hippocampus and the entorhinal cortex play an essential role in the formation of these memories (Eichenbaum, 2000).

The hippocampus structure is composed of different elements. The inputs of the hippocampus are obtained from the sensorial system, via the EC. Different layers of neural fibres (II, III, IV and V), project from the EC to the hippocampus. Each of these layers enter the hippocampus in different places, through the perforant path-way.

One of the main inputs of the hippocampus is the Dentate Gyrus (DG). The DG structure is considered to work as a pattern separator, meaning that this element classifies the data provided by the EC (Cherubini & Miles, 2015). Some studies have shown that the DG allows the discrimination of the location of two identical objects, with a certain physical distance between them (Teyler & Rudy, 2007).

Another set of important components are the Cornu Ammonis (CA) elements. The CAs are complex mechanisms which are divided in different areas, numbered from 1 to 4 (i.e. CA1, CA2, CA3 and CA4). CAs are considered responsible for the association between elements, creating episodic sequences and using those episodes to acquire new information (Farovik et al., 2010).

After the CA areas, there is an element called subiculum. The subiculum is composed of three different subareas: (1) An area that connects directly with outputs of the CA1, (2) a pyramidal cells area and (3) the area that connects with the EC. Research that study lesions in the subiculum suggests that it plays an important role in spatial memory. It can assist the hippocampus in order to form a long-term memory and it can also amplify the hippocampus output (O'Mara et al., 2001). Boundary or border cells, that signal the presence of an environmental boundary have been identified in the subiculum (Lever et al., 2009). According to (Poulter et al., 2018) the subiculum can also be an input of the hippocampus sending information regarding the boundaries of the environment and that information can be used during the theta precession stage (Hafting et al., 2008).

The entorhinal cortex interconnects the hippocampus with the neocortex, being a part of the parahippocampal system. The MEC, when compared with the LEC, receives more inputs from regions associated with visuospatial areas (Burwell and Amaral 1998; Witter and Amaral 2004). It is also known to encode spatial information (Fyhn et al. 2004; Hafting et al. 2005; Hargreaves et al. 2005; Quirk et al. 1992)(Hargreaves et al., 2005) and to perform path and time integration (Fukawa et al., 2020)(Kraus et al., 2015). Grid Cells are responsible for these encodings, allowing an integrated representation of the animal's location in space and time.

Structurally, within the superficial MEC, two nonoverlapping modular systems, namely calbindin and zinc patches, receive largely segregated inputs, from the para-subiculum and presubiculum (Ray et al., 2014). Calbindin patches in Layer II are organized in a periodic and/or a hexagonal pattern and are superimposed on scattered stellate cells. These patches are made of pyramidal neurons, whose dendrites bundle together and form a curvilinear matrix of structures, called Island cells, with a bulb-like (Kitamura et al., 2014) or tent-like (Naumann et al., 2018) shape. These Island Cells, which are present in both MEC and LEC, are separated by Zinc patches that occupy the space between them.

While these mechanisms are still poorly understood from a functional perspective, it makes sense to define a model that approximates the information that mean-while has been observed. That is the aim of the following sections.

### Determination of a Location in Space

To find a location of a specific asset or element in a two-dimensional space, several methods can be used. One of them is the triangulation. The triangulation method requires a set of points and a way to extract information between the current location of the element and the observed points. Robots can create this type of behavior by extracting distance information with the help of beacons (Esteves et al., 2003). Triangulation is also used in cellular networks (Malik et al., 2011) to determine the location of a node, by measuring the power received by at least three base stations. In another example, Global Positioning Systems (GPS) defines the position of a device by measuring the distance to at least three satellites, in a process called trilateration (“Glob. Navig. Satell. Syst. Signal, Theory Appl.,” 2012).

Besides the triangulation method, other solutions allowed humans to navigate around the Earth with the help of instruments. In the year 1500 a.c., improved versions of the astrolabio and quadrant (Richey, 1992) allowed the discovery of the sea route from Europe to India and to Brazil, by the observation of the angle of the sun and of some of the stars. In fact, stars and constellations were the marks that allowed it, but a method was created to use them.

Nowadays gyroscopes are normally used for that purpose. The gyroscope is composed by gimbals and was invented by John Serson in 1743 and later adapted by Johann Bohnenberger with the function to find the horizon line (v. Bohnenberger, 1818). This instrument can be found in inertial measurement units and allows the identification of a point in space by calculating the angular velocity on different axis. However, the usage of this instrument can cause different types of errors, due to what is called the gyroscope drift (Wrigley & Hollister, 1965). The gyroscope drift occurs when the intersection of the different gimbals causes a difference between the initial orientation and the current one.

While these methods allow the navigation around the globe, these solutions do not allow a coherent indexing of geospatial data that exists at different spatial scales. That coherent identification requires the partitioning of the earth into logical structures that take into account the heterogeneity of the scales of that data (Goodchild & Kimerling, 2002). In fact, the indexing of spatial data and its integration is currently a prevailing requirement in geospatial analysis and computation (Bondarukl et al., 2019). In this field, Discrete Global Grid Systems (DGGS) like the H3 Hexagonal Hierarchical Geospatial Indexing System (Sahr et al., 2018) from Uber Tecnologies Inc., and the OpenEAGGR (Bush, 2017) are being used as new models for spatial data indexing (Li, 2013)(Mandavi-Amiri, Ali; Alderson, Troy; Samavati, 2016).

As described in (Goodchild & Kimerling, 2002) an ideal global partitioning system of space would generate grid cells that are equal in surface area and identical in shape. In it, the authors identify two methods that allow the indexing of the surface of a sphere, which allow the indexing of areas in the surface of the Earth. In one of the methods of subdividing a triangle (Goodchild & Kimerling, 2002), they consider a four-fold subdivision, where the three edges of a triangle are bisected, producing four sub-triangles within the triangle. The method is repeated recursively, generating different recursion levels. These levels enable the scaling of the method to enable any resolution.

In our perspective, the same requirements that led to the definition and usage of Discrete Global Grid Systems, and in particular the coherent indexing of geospatial data, that these methods allow, may have contributed to the existing structure of Grid Cells in animal's brains.

### Computational Representations of Grid Cells

According to the “Computational Models of Grid Cells” (Giocomo et al., 2011), there are different types of grid cell models, namely: (1) the Oscillatory-Interference Model; (2) the Attractor-Network Models; (3) a Self-Organized Model and (4) the Path-Integration Model.

The Oscillatory-Interference Model (Burgess et al., 2007) is based in the idea of the phase precession method (Hafting et al., 2008). Two oscillators are implemented. One maintains the frequency constant while the other increases or decreases frequencies based on the input. When a threshold is achieved it will result in a phase change causing a difference between the oscillator and velocity. One side effect of this model is the creation of repeated place fields that were not seen at the time. When the difference between oscillators is a multiple of 60 degrees a triangular grid is created. However, this model is not plausible on a biological system because the implemented oscillators have perfect sinusoids and with noise the performance of the model is significantly lower. One method to solve this challenge is to update the network with environmental landmarks. The firing pattern of the grid cells can be maintained for a period of ten minutes before complete darkness. The stability of the model is obtained by connecting the oscillators using inhibitory and excitatory entries.

The Attractor-Network Model (Fuhs, 2006)(McNaughton et al., 2006)(Guanella et al., 2007) is another computational representation of the grid cells. A single position in the grid is represented as an attractor with an activated state and using recurrent connections. A specific set of inputs might activate the neurons in the net. If the recurrent connection is stronger than the connection of the neighbors, the spike will occur in a different part of the net and the incoming information directly influences the location of the spike. The information encoded via HD cells can be implemented using an element called a one-ring attractor by putting the different cells in a circular form and according to the preferred direction. This model can also be used to represent the behavior of the entorhinal network. This navigation model, used over different periods of time, allows the creation of grid cell patterns but it requires a boundary, to act as a identifier of environmental boundaries and a activation function responsible for the control of firing of the initial connections in order to avoid a possible overfitting of data. In order to add the temporal information necessary to create a phase precession, a tours-based model has been proposed. Two connected networks are used to simulate the theta rhythm wave and with this feature it is possible to follow the movement and direction of the individual. This model was made based on the assumption that the phase of the wave that has spatial information is directly linked to a spike on the grid cell network.

A Self-Organized Model (Urdapilleta et al., 2017) consists in creating an emphasis on inputs that are separated by a 60-degree angle. This model assumes that grid cells receive data from a group of cells called stripe cells. The stripe cells fire different stripes into the environment and the junction of the linear velocity and the allocentric direction allows the creation of constantly spaced paralleled lines. The direction vector is perpendicular to the stripe cells lines (Pilly & Grossberg, 2014) . The ring attractor network is used to extract data from the velocity signal and the movement of the individual is reflected into the stripe cells by using a competitive learning process. This method allows the generation of hexagonal patterns. The Hebbian learning method can be used to implement the competitive learning by giving strength to cells that have a 60-degree orientation. This model has features from the models mentioned above and its main idea is that cells can create stable hexagonal patterns on a short time.

The Path-Integration-Free Model (Kropff & Treves, 2008) suggests that the formation of grid cells are only made with spatial and velocity inputs. This model also uses Hebbian learning to form/organize the network and the neurons must have a special feature to allow the adaptation to different situations like the average velocity multiplied by a time factor. In this model the grid fields might have random orientation, and these can be placed by using excitatory recurrent connections.

These models make a number of hypotheses, that can be tested in the future. Until now the results obtained from experimental evidences are subject to multiple interpretations. As improvements are made in such methods, the required alignment between theory and reality will gradually be strengthened. While these improvements in experimental methods do not allow verification, it is important to define computational models to provide a fundament for the subsequent testing, as these methods become available.

### Gray Codes

As previously stated, an encoding of spatial locations should assure similarity and continuity between neighbor locations. Gray codes are a way to guarantee these requirements. A code is considered a Gray Code if any two neighbor code words differ in one bit position only, i.e. have an Hamming Distance of one.

The Gray codification is used in many different applications like position encoders (Dean H. Symonds, 1990), genetic algorithms (de Oliveira & Santos-Magalhães, 2004), communications and error correction mechanisms (Pham et al., 2011).

Gray Codes are used in linear and rotary position encoders, especially those that are based in microelectromechanical systems, because only one-bit changes between adjacent positions, avoiding erroneous encodings that result from non-simultaneous changing of several bits. In fact, in these cases, an encoder that uses a pure binary numbering to translate a position can lead to significant position errors. Also using Gray Codes, the maximum position error when sampling at discrete intervals will be small, because any obtained position will always be close to the actual position.

In digital logics, Gray Codes are used in the two axes of Karnaugh Maps, allowing the minimization of the logical functions that translate logical conditions. The Gray Coding of the variables of the axes of Karnaugh Maps orders the neighboring conditions within the map, in a way that allows generalization, and aggregation, minimizing the number of logical gates that are required to implement these conditions.

Finally, given a certain state and a notion of direction, the similarity between adjacent points allows a better prediction of the next state.

These properties make it the ideal coding scheme for any spatial and timing encoder.

### Solution to Problem

The requirements of similarity and continuity can be met with a Gray Code, because it assures that any two adjacent code words differ in one bit position only, and that, two short-distance values have short-distant encodings in terms of Hamming distance. In order to support scalability, the encoding should be multilayered or multilevel, as it allows more combinations than non-coded solution.

The method according to the present invention uses a hexagonal coordinate system, which contributes with higher precision indexers of the points that are inside a certain area.

The present invention uses a hexagonal coordinate system as an indexing method for spatial spaces, based in a multilayer hexagonal coordinates system, that bridges together these two areas of research. The method is supported in a new type of Gray Coding that allows the representation of two-dimensional spaces, but also, of one-dimensional variables, like time and any other input from sensors. The encoding is derived from a multilayer ternary encoder, generated from an equilateral triangle. After defining a space filling method for that two-dimensional architecture, the present invention derives two Gray Codes for one-dimensional signals, either to be used with signals that show a circular or periodic pattern and for non-circular ones. The resulting model for Grid Cells is then successfully applied in a navigational system of a robot, generating patterns of Grid Cells similar with the ones observed in neuroscience.

### Advantageous Effects of Invention

In this patent application, it is disclosed a representation that unifies the views pertinent to biological based grid cells and non-biological ones, developing new types of Gray encodings for both one- and two-dimensional spaces. The invention comprises the definition of a multilayer ternary encoder based in an equilateral triangular coordinate system. After defining a space filling method for this two-dimensional architecture, two Gray Codes for one-dimensional signals are defined, for both circular/periodic and non-circular representations of signals. An algorithm is defined to build the two-dimensional Gray Encoding of Grid Cells, which is then successfully applied in a navigation system of a robot, generating patterns of Grid Cells similar with the ones observed in neuroscience.

### BRIEF DESCRIPTION OF DRAWINGS

With the purpose of providing an understanding of the principles according to the embodiments of the present invention, reference will be made to the embodiments illustrated in the figures and to the language used to describe them. In any case, it must be understood that there is no intention of limiting the scope of the present invention to the contents of the figures. Any subsequent alterations or modifications of the inventive characteristics here illustrated and any additional applications of the principles and embodiments of the invention shown, which would occur naturally to a person skilled in the art holding this description, are considered within the scope of the claimed invention.

FIG. 1 shows a triangular coordinate system for two-dimensional spaces;

FIG. 2 shows a discretization of the two-dimensional space using the proposed triangular coordinate system;

FIG. 3 shows a resulting Gray code of a surface encoding according to the invention;

FIG. 4 shows an aggregation of multiple areas using hexagons, represented from the lowest layer to the top layer;

FIG. 5 shows a non-circular encoding of the proposed Gray Code for a one-dimensional space;

FIG. 6 shows a generation of the non-circular Gray code using circular encoders. The dashed lines represent the initial phase;

FIG. 7 shows a circular encoding of the proposed Gray Code for a one-dimensional space generating 24 code-words;

FIG. 8 shows a generation of a circular Gray code using circular encoders;

FIG. 9 shows an encoding of three layers of Grid Cells using the three Gray encoded axes;

FIG. 10 shows an algorithm for the computation of the Grid Cells in one Layer;

FIG. 11 shows a three layer of Grid Cells in obtained in the webots environment;

FIG. 12 shows the encoding of a spatial space with an obstacle using Grid Cells, as obtained by the webots environment.

### DESCRIPTION OF EMBODIMENTS

The present invention, in a first aspect, refers to a computer implemented method for the indexing of two-dimensional spaces, comprising the following steps:
a) Spatial indexing of a two-dimensional space by using Grid Cells,
wherein the spatial indexing is based in a triangular coordinate system based in equilateral triangles;
b) Association of at least one vertex of at least one equilateral triangle of the triangular coordinate system with a first ternary code;
c) Subdivision of at least one equilateral triangle obtained in the step b) forming a plurality of layers L,
wherein each edge of said equilateral triangle is bisected forming four sub-triangles incorporated within the said equilateral triangle, and
at least one node of the formed sub-triangle is encoded with a second ternary code, and
where the subdivision of an equilateral triangle of a layer Li occurs, four lower level sub-triangles of a layer Lᵢ₋₁ are created, and wherein the step c) is repeated recursively, wherein i, starting at 0, specifies a subdivision index;
d) Space filling of an area within at least one equilateral triangle or at least one sub-triangle obtained in the step c) by means of an encoding by at least one element selected from the group consisting of a quaternary code, a third ternary code or a binary variable;
e) Generation of a hexagonal coordinate system based on a grid of equilateral triangles and their respective subdivided triangles for two-dimensional spaces.

The present invention, in a second aspect, refers to a robot location system, which is configured to map a deployment area, comprising:
a computational processor, wherein the said computational processor is configured to receive an input information about a head direction or an angular direction of an autonomous robot; and
a computational memory, which is configured to store values generated by the said computational processor, wherein the said computational processor is configured to execute the following steps:
a) Spatial indexing of a two-dimensional space by using Grid Cells,
wherein the spatial indexing is based in a triangular coordinate system based in equilateral triangles;
b) Association of at least one vertex of at least one equilateral triangle of the triangular coordinate system with a first ternary code;
c) Subdivision of at least one equilateral triangle obtained in the step b) forming a plurality of layers L,
wherein each edge of said equilateral triangle is bisected forming four sub-triangles incorporated within the said equilateral triangle, and
at least one node of the formed sub-triangle is encoded with a second ternary code, and
where the subdivision of an equilateral triangle of a layer Li occurs, four lower level sub-triangles of a layer Lᵢ₋₁ are created, and
wherein the step c) is repeated recursively, wherein i, starting at 0, specifies a subdivision index;
d) Space filling of an area within at least one equilateral triangle or at least one sub-triangle obtained in the step c) by means of an encoding by at least one element selected from the group consisting of a quaternary code, a third ternary code or a binary variable;
e) Generation of a hexagonal coordinate system based on a grid of equilateral triangles and their respective subdivided triangles for two-dimensional spaces.

In a third aspect, the present invention refers to a computer program, which comprises instructions which, when the program is executed by a computer, cause the computer to carry out the steps of the method defined in the first aspect of the present invention.

In a fourth aspect, the present invention refers to a computer-readable data carrier having stored thereon the computer program, as defined in the third aspect of the present invention. The computer-readable data carrier can comprise, for example, one or more optical disks, volatile memory components (such as DRAM or SRAM) and/or nonvolatile memory components (such as hard drives, Flash RAM or ROM). The computer-readable data carrier may also be distributed over network coupled computer systems so that the computer program is stored and executed in a distributed fashion.

### Relevance of Path and Time Integration in Machine Learning

In this section, it is defined a Gray code for the encoding of two- and three-dimensional spaces. The section starts with the analysis of the relevance of integrating path and time information in a Machine Learning.

As previously stated, the MEC is known to encode spatial information (Fyhn et al. 2004; Hafting et al. 2005; Hargreaves et al. 2005; Quirk et al. 1992), and to perform path and time integration (Fukawa et al., 2020)(Kraus et al., 2015). The method that is used to compute a location in space may also allow obtaining a measurement of where the animal is in time. The major difference between these measurements is that time only moves forward, while spatial location depends on the head direction and on the moving speed. Yet, variables that depend on time tend to have cyclical patterns, in consecutive days, weeks and years.

In order to perform the integration of time, we, humankind have defined the notion of clock. When measuring time, we have distinct scales, namely seconds, minutes, hours, days, weeks, months and years. These encodings of time are circular, which means that they have a period of repetition. The lower the level of the scale, the higher the precision it enables.

Similarly, Grid Cells have also different layers and scales. These different layers enter the hippocampus in different locations. More specifically, Layer II makes excitatory synapses onto both the granule cells of the Dental Gyrus and the pyramidal cells of the CA3, whereas layer III and V synapse onto the both the CA1 and subiculum. The spatial scale of grid firing fields increases from the dorso to the ventral axis of the medial entorhinal cortex (Hafting et al., 2005). Particularly, Grid Cells within Layer II of the MEC, have widely varying spatial frequencies (Hafting et al., 2005) ranging from 30 cm to over 8 m (de Almeida et al., 2009).

If we think about a machine learning algorithm that is used to analyze the data from several sensors, the notions of time, reflected in its scale and periodicity, is very important to allow a better estimation of the value of one of the measured variables. For instance, to predict the normal consumption of a building, a machine learning algorithm normally uses the information gathered from different sensors, including outside temperature, humidity, solar radiation, building occupancy, among others, but also, it usually considers the information about the hour of the day, day of week and month where these measurements were made. In fact, the consumption of a building tends to have similar patterns over these time scales. In this situation, it is undeniable that the notion of time is essential to get a better estimation of the consumption. But is it clock time the best indexer of time? How can this indexing of time be obtained from the observed data? To answer these questions a time scale must be built.

Humankind defined the scales and periodic length of each of these variables by observing the variables that are periodic in nature, like the position of the sun and of the stars. The twenty-four hour division of day and night started by the Egyptians that divided the night-time on 12 hours using a set of 36 star groups called Decans (Neugebauer, 1955).

Somehow our brain needs to do the same when indexing time and space. In terms of space, it needs to be done with distinct levels of precision, and with the notion of periodicity. Periodicity in space occurs whenever an animal gets back to a location where it was before. When this occurs, the variables we sense should be used to reinforce the knowledge of that location, not being confused with some other new site.

So, if the hippocampus can be seen as the indexer of the neocortex, we consider that Grid Cells and head direction information from the EC can in turn be seen as a space/time indexer of the hippocampus.

### Requirements for the Spatial Encoding

As stated in (Hafting et al., 2005) the firing fields of Grid Cells: (1) show a repetitive equilateral triangular structure and (2) form hexagons of equidistant firing peaks, at multiples of the distance to the nearest hexagon. So, considering that Grid Cells encode the integration of the path, the present invention considers that a triangular coordinate system must constitute the basis for that spatial encoding.

One of the requirements for that coordinate system is that the spatial indexing method should assure that two adjacent locations have a high degree of similarity. Also, the encoding system must be immune to transition errors when moving between adjacent locations. It should also allow the logical aggregation of locations to enable the indexing of assets and objects that might span over several spatial units.

Another requirement about the data indexing method is the ability to support periodicity. By looking to the notion of time and space, it is possible to conclude that in some cases the data tends to repeat after certain periods. The analysis of variables that lead to that periodicity is very relevant. As the EC receives projections from the subiculum, the periodicity of the Grid Cells will result from the periodicity of the representations of data at that point.

While in some cases the periodicity is clear, in other cases it is unclear if the observed data is going to have a repetition pattern. Therefore, the index should allow both the encoding of sequences that are periodic and non-periodic, of any length and of any definition.

The spatial encoding must take into consideration the different layers of Grid Cells, combined to get a unique encoding of each place in the environment. This means that for a given encoding, only one specific area should be associated. We consider that in the hippocampus, the uniqueness of the encoding of a place is directly proportional to the uniqueness of the encoding coming from the EC and the remaining data that enters it. So, this requirement may be relaxed when considering the hippocampal system as a whole.

Finally, the encoding should also be scalable, which means that the size of each encoded area and the coverage will depend on the number of layers. The proposed solution should allow the coverage of small areas and, at the same time, scale to enable the coverage of large areas.

### A Triangular Coordinate System

In this section, a multilayer ternary encoding is presented for triangular coordinate systems.

As previously stated, in (Goodchild & Kimerling, 2002) the authors consider a recursive four-fold subdivision of a triangle, where the three edges of that triangle are bisected, producing four sub-triangles within the triangle. The method is repeated recursively, generating what they call recursion levels.

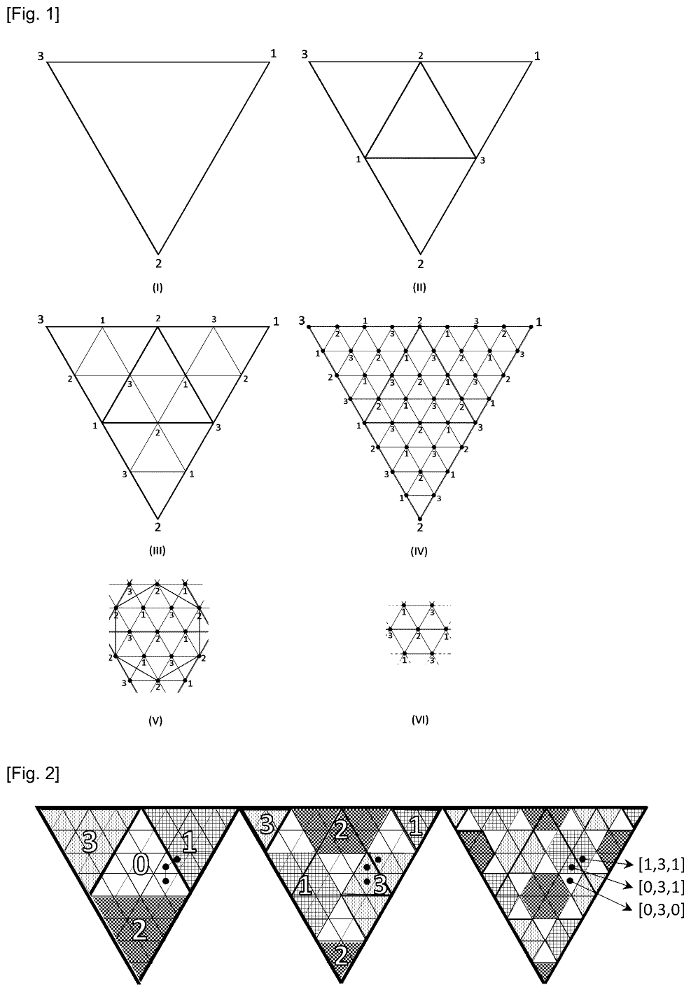

Similar to that method, in this section it is specified a triangular coordinate system for the present invention. However, the triangular coordinate system is associated with a ternary encoding. Let's start by considering an equilateral triangle, as the one shown in the top left image of FIG. 1. Let's also consider that each of the vertices of that triangle is encoded with a ternary code (in this case 1, 2 and 3).

In the FIG. 1, the image (I) represents the initial triangle with the ternary encoding; image (II) represents the subdivision of the initial triangle and the associated encoding of the nodes; image (III) represents following layer with 15 points; image (IV) represents the lowest layer with 45 points; images (V) and (VI) show the hexagonal grids that are formed resulting from the ternary encoding and consecutive partitioning method.

In the preferred embodiments according to the present invention, the step c), which regards the subdivision of at least one equilateral triangle obtained in the step b) forming a plurality of layers L, inside any equilateral triangle of a certain layer L, three vertices are kept, and three new vertices are created, and each vertex is encoded with a different second ternary code.

Starting at this point, a sequence of layers is going to be defined by a recurrent procedure that uses the previous layer to build a new one. The procedure is the following. At each of the layers, each of the edges of the triangles is bisected in two equal segments, creating a set of four smaller triangles inside the initial one, as shown in the top-right image of FIG. 1. So, inside any triangle of a certain layer, three vertices are kept, and three new vertices are created. Each of these new vertices will be encoded with the following method: given the ternary encoding (1, 2, 3 associated to any nodes A, B and C), the code given to a new vertex that result from the bisection of an edge between two vertices A and B, will always be coded with a symbol different from A and B, thus being equal to the content of C. For instance, if an edge connecting two vertices 2 and 3 is bisected, the newly created vertex will be encoded as 1. The same applies to any set of nodes to be bisected. The encoding of the other three vertices of the new layer are kept equal to the encoding of the previous layer. In the following we will call this procedure the exclusivity rule, as it assures that a node encoded with a ternary symbol do not have a direct link to any other node with its same encoding.

In the preferred embodiments according to the invention, in the step e), which regards the generation of a hexagonal coordinate system based on a grid of equilateral triangles and their respective subdivided triangles for two-dimensional spaces, a ternary code of a node of a hexagon is different from a ternary code of a direct neighbor node.

As can be verified in FIG. 1, as highlighted in images V and VI, the structure and associated encoding of all layers, form a grid of tessellating equilateral triangles, spanning through the whole of the original area. The ternary encoding, generates hexagons, where any direct neighbors of any node, do not have a symbol equal to its own.

This subdivision process can be repeated any number of times. It is rep-tile. In each step, a new layer grid is created, with smaller triangles. The number of points in each subdivision i can be obtained using the equation (1):

$$Points ( i ) = \frac{{( {2}^{i} + 1 )}^{2} + ( {2}^{i} + 1 )}{2} \qquad [ Math . 1 ]$$

where i, starting at 0, specifies the subdivision index.

This method enables the encoding of the points that belong to the vertices of each triangle in each layer but does not explain how to encode the points that stand inside each triangle. As in any quantification process, any point inside these triangles need to be discretely encoded. In the following we will propose a multilayer solution for that process.

### Encoding of Spatial Locations

This section presents a space filling method, that enables the encoding of all areas within each triangle that results from the fragmentation described in last section. Starting from the highest layer, the process recurrently encodes several lower layers.

As verified previously, whenever a fragmentation of one triangle of layer Lᵢ occurs, four lower level triangles of layer Lᵢ₋₁ are created. To encode each of these four triangles we are going to consider that a quaternary code is used, with the symbols 0, 1, 2 and 3. FIG. 2 left side image, represents the discretization of the two-dimensional space using the proposed triangular coordinate system, where the left image represents the top layer (L3), the central image represents the Medium Layer (L2) and the right image represents the Lower Layer (L1). It works as follows: (1) each of the triangles that is closer to a vertex (as shown in FIG. 1), assumes the code of that vertex, and (2) the triangle that is at the center, equidistant from any of these vertices, assumes the value of 0 (or NULL).

For the encoding layer Lᵢ₋₂ each of the triangles of the layer Lᵢ₋₁ is further fragmented in four smaller triangles. Again, each of the new triangles in FIG. 2 that is closer to a vertex of FIG. 1 assumes the value of that vertex, resulting in the representation shown in FIG. 2 center image.

This process may be recurrently repeated any number of times. FIG. 2 right image shows such a representation for the layer Lᵢ₋₂. It can be verified that, as this process repeats, hexagons for the areas 1, 2 and 3 will be formed, as represented in the right image of FIG. 2. These hexagons are organized in equilateral triangles and higher-level hexagons, when scaling up. Between them, NULL or 0 valued triangles will be placed.

This solution assures that each of the triangles of the lowest layer will be given a unique encoding. For instance, the encoding [L3; L2; L1]=[0; 3; 1] of the triangle represented in FIG. 2 right side, is unique within the whole initial triangular area. It also assures that this process can be repeated any number of times, resulting in any 2D coverage and definition. The process is rep-tile.

The symbol 0 of the quaternary encoding, may either be represented as a function of the other three symbols or by the absence of an encoding. Although this latter option may seem uncommon, it is in fact used in digital communications, as for instance in the On Off Keying (OOK) modulation, a particular case of the Amplitude Shift Keying (ASK) modulation that do not send any signal when transmitting a logical 0.

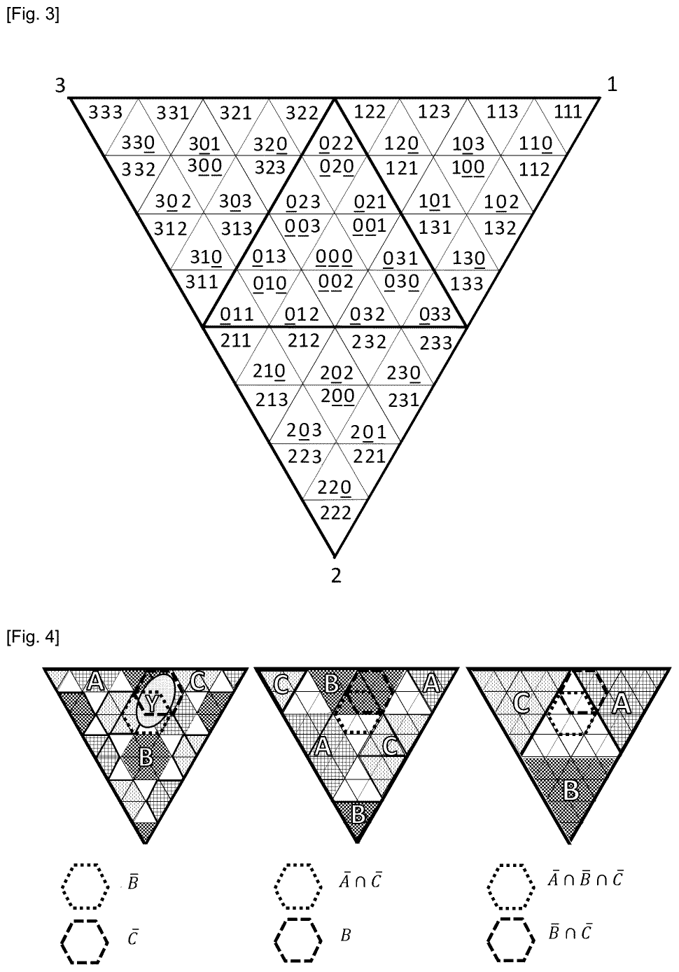

A complete Gray encoding, according to a preferred embodiment of the invention, is shown in FIG. 3. It can be verified that each small triangle has a unique identification. The representation of each layer is made from the left to the right, meaning that the most left value corresponds to the highest layer and the rightest value element corresponds to the lowest layer. If a new area is required, it can be obtained from the unfolding of this triangle using one of its edges. Then, the differentiation between these triangles is made using an upper layer, that needs to be added.

This solution assures that the transition between edges of the triangle results in a Hamming distance of 1. If the transition is made between vertices of opposite triangles, two ternary symbols will need to be changed. However, it can be verified that any of the codewords that stand in between these two codewords are always associated with neighbor triangles, and thus these temporary encodings will not be associated with distant locations.

Let's now consider that, instead of using the quaternary code previously defined we consider three binary variables A, B and C, that replace the encodings 1, 2 and 3 used in FIG. 2. In this case the 0 or NULL (white) area is represented as (Ā∩B̅∩C̅) where the Ā, B̅ and C̅ respectively represent the area that is not within the A, B or C triangles. The A, B and C variables are mutually exclusive, which means that any two of these variables cannot be active simultaneously.

The same method enables obtaining the sub areas (Ā∩B̅), (B̅∩C̅) and (Ā∩C̅).

In the preferred embodiments according to the present invention, the step e), which regards the generation of a hexagonal coordinate system based on a grid of equilateral triangles and their respective subdivided triangles for two-dimensional spaces, is executed from a lower layer Lᵢ₋₁ to a higher layer Li.

One important feature that results from this representation is that it allows the aggregation of neighbor triangles, forming hexagons that simplify the logical conditions required to represent each of these areas. For instance, in order to encode/index the area Y shown in FIG. 4 (left side), which may translate a spatial cue, two hexagons can be used. One hexagon can be represented by [L₃; L₂; L₁]=[Ā∩B̅∩C̅; Ā∩C̅; B̅] and the other hexagon can be represented by [L₃; L₂; L₁]=[B̅∩C̅; B; C̅]. These two hexagonal aggregations replace the encoding of ten triangles, namely {[1; 2; 2], [0; 2; 2], [1; 2; 0], [0; 2; 0], [1; 2; 1], [0; 2; 3], [0; 2; 1], [0; 0; 3], [0; 0; 1], [0; 0; 0]} as represented in FIG. 3. This process, that is performed from the lowest to the highest layers, significantly reduces the number of conditional detectors required to index areas. Also, as the two hexagons are partially overlapped, there is a continuity between the associated spatial representations, avoiding transition glitches/errors when moving between adjacent hexagons, inside an area. This process is similar with the one used in Karnaugh Maps to simplify real-world logic, so that it can be implemented using a minimum number of logic gates. The main difference is that, in this case, multilevel hexagonal aggregations are used, instead of the rectangular ones used in Karnaugh Maps.

This same process can be repeated in any higher layer, allowing the formation of larger hexagons that translate larger areas. For instance, a larger hexagon in the middle layer can be built using [L₃; L₂; L₁]=[Ā∩B̅; C̅; x], where the x represents a “don't care” condition, i.e. any value is valid.

We hypothesize that these aggregations might be performed in the CA areas of the hippocampus that receive the projections of the Grid Cells, leading to what is known as Place Cells. The aggregation process here proposed reduces the number of required conditional detectors required to index geospatial data that exists at different spatial scales, and thus takes into account the heterogeneity of the scales of that data.

After defining the two-dimensional Gray encoding, we now proceed to define a method that can be used to generate it.

### A Gray Encoding for One-Dimensional Maps

This section presents a Gray Encoding for one-dimensional maps.

In order to illustrate an embodiment of the invention, the purposes of this and next sections is to define a method that allows the implementation of the Gray encoding of the 2D map specified in FIG. 2. Before defining the 2D encoding in order to generate a second Gray Code for representing a bidimensional area, we start by deriving an 1D first Gray Code for representing a one-dimensional variable that will be used as axes in the three sides of the triangles shown in the previous section.

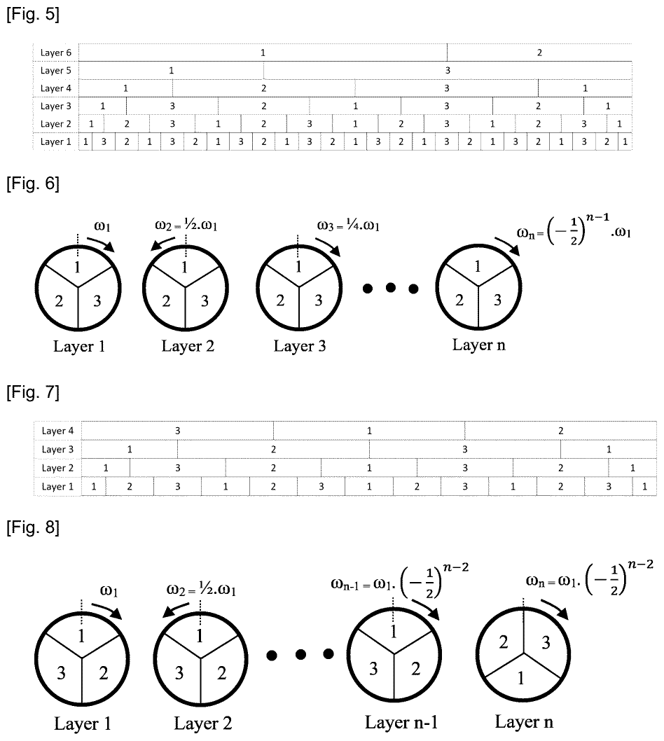

In order to build these axes, let's consider a walk that goes through the boundary line of the equilateral triangle represented in the left side of FIG. 2. Starting at the vertex 1 of this triangle and following clockwise the boundary line, the encoding that results from that walk is the one represented as Layer 4 in FIG. 5. When this procedure is repeated for the triangle at the center of FIG. 2, the encoding that results from this procedure is the one shown in Layer 3 of FIG. 5. The same procedure, applied to boundary of the right-side triangle of FIG. 2, leads to the encoding shown in Layer 2 of FIG. 5.

Besides these three layers, more layers can be added in the top and bottom of this initial set, resulting in more codewords and enabling achieving any required resolution and scope. These additional layers are identified as Layers 1, 5 and 6, in FIG. 5. Only a part of Layers 5 and 6 are represented, as they span beyond the interval shown.

The generation of this 1D Gray code can be performed by a set of neurons, each one having their own tuning curve. As described in the Neural Engineering Framework (Eliasmith & Anderson, 2003), distinct neurons can have different tuning curves, that characterize the sensibility each one has to a given input interval. The main characteristic of the encoding here proposed is that it has different layers of neurons, each one with three sets of neurons, that have tuning curves that repeat in a periodic and alternating way. When analyzing the structure of the entorhinal cortex, the Calbindin patches in Layer II might be the places where this encoding is performed. As described, these patches are made of pyramidal neurons organized in a periodic and/or hexagonal pattern, whose dendrites bundle together and form a curvilinear matrix of structures, with a bulb-like (Kitamura et al., 2014) or tent-like (Naumann et al., 2018) shape. We hypothesize that that bulb-like structure of pyramidal neurons can be used to generate an encoding similar with the one here proposed.

Different methods can be used to generate the encoding shown in FIG. 5. As can be verified, the two upper layers (Layers 6 and 5) divide the input scale in three quantization intervals (QIs). Then Layer 4 further subdivide each of these 3 QIs in two equal parts, thus introducing 3 partitions, creating a total of 6 QIs. Layer 3 adds 6 partitions, resulting in a total of 12 QIs. Layer 2 adds 12 more partitions, resulting in a total of 24 QIs. Finally, Layer 1 further fragments each of these layers in two, leading to a total of 48 QIs.

The defined encoding can also be implemented using circular encoders, as shown in FIG. 6.

The above described procedures generate a Gray Code, as the one shown in Table 1. It can be easily verified that the Hamming distance between two consecutive encodings will always be equal to 1, assuring a high degree of similarity between consecutive encodings.

TABLE 1

Gray Code

| Decimal | L₆ | L₅ | L₄ | L₃ | L₂ | L₁ |
|---|---|---|---|---|---|---|
| 0 | 1 | 1 | 1 | 1 | 1 | 1 |
| 1 | 1 | 1 | 1 | 1 | 1 | 3 |
| 2 | 1 | 1 | 1 | 1 | 2 | 3 |
| 3 | 1 | 1 | 1 | 1 | 2 | 2 |
| 4 | 1 | 1 | 1 | 3 | 2 | 2 |
| 5 | 1 | 1 | 1 | 3 | 2 | 1 |
| 6 | 1 | 1 | 1 | 3 | 3 | 1 |
| 7 | 1 | 1 | 1 | 3 | 3 | 3 |
| 8 | 1 | 1 | 2 | 3 | 3 | 3 |
| 9 | 1 | 1 | 2 | 3 | 3 | 2 |
| 10 | 1 | 1 | 2 | 3 | 1 | 2 |
| 11 | 1 | 1 | 2 | 3 | 1 | 1 |
| 12 | 1 | 1 | 2 | 2 | 1 | 1 |
| 13 | 1 | 1 | 2 | 2 | 1 | 3 |
| 14 | 1 | 1 | 2 | 2 | 2 | 3 |
| 15 | 1 | 1 | 2 | 2 | 2 | 2 |
| 16 | 1 | 3 | 2 | 2 | 2 | 2 |
| 17 | 1 | 3 | 2 | 2 | 2 | 1 |
| 18 | 1 | 3 | 2 | 2 | 3 | 1 |
| 19 | 1 | 3 | 2 | 2 | 3 | 3 |
| 20 | 1 | 3 | 2 | 1 | 3 | 3 |
| 21 | 1 | 3 | 2 | 1 | 3 | 2 |
| 22 | 1 | 3 | 2 | 1 | 1 | 2 |
| 23 | 1 | 3 | 2 | 1 | 1 | 1 |
| 24 | 1 | 3 | 3 | 1 | 1 | 1 |
| 25 | 1 | 3 | 3 | 1 | 1 | 3 |
| 26 | 1 | 3 | 3 | 1 | 2 | 3 |
| 27 | 1 | 3 | 3 | 1 | 2 | 2 |
| 28 | 1 | 3 | 3 | 3 | 2 | 2 |
| 29 | 1 | 3 | 3 | 3 | 2 | 1 |
| 30 | 1 | 3 | 3 | 3 | 3 | 1 |
| 31 | 1 | 3 | 3 | 3 | 3 | 3 |
| 32 | 2 | 3 | 3 | 3 | 3 | 3 |
| 33 | 2 | 3 | 3 | 3 | 3 | 2 |
| 34 | 2 | 3 | 3 | 3 | 1 | 2 |
| 35 | 2 | 3 | 3 | 3 | 1 | 1 |
| 36 | 2 | 3 | 3 | 2 | 1 | 1 |
| 37 | 2 | 3 | 3 | 2 | 1 | 3 |
| 38 | 2 | 3 | 3 | 2 | 2 | 3 |
| 39 | 2 | 3 | 3 | 2 | 2 | 2 |
| 40 | 2 | 3 | 1 | 2 | 2 | 2 |
| 41 | 2 | 3 | 1 | 2 | 2 | 1 |
| 42 | 2 | 3 | 1 | 2 | 3 | 1 |
| 43 | 2 | 3 | 1 | 2 | 3 | 3 |
| 44 | 2 | 3 | 1 | 1 | 3 | 3 |
| 45 | 2 | 3 | 1 | 1 | 3 | 2 |
| 46 | 2 | 3 | 1 | 1 | 1 | 2 |
| 47 | 2 | 3 | 1 | 1 | 1 | 1 |

The Gray Code shown in FIG. 5 is not closed. Thus, upper layers can always be added. The minimum number of layers should always be 2. For any number of layers NL≥2, the number of QIs (NQI) of the non-circular code, can be obtained using equation 2.

NQI(NL)=3×2^{(NL-2)}, NL≥2 [Math. 2]

In order to transform this non-cyclic encoding, into a cyclic encoding, the two upper layers must be replaced by one closed sequence, that violates the alignment (and the rule) that was previously used in the non-cyclic code to generate upper layers. An example of that procedure can be verified by observing the top layer of FIG. 7.

The generated Gray Code is shown in Table 2.

TABLE 2

Gray Code

| Decimal | L₄ | L₃ | L₂ | L₁ |
|---|---|---|---|---|
| 0 | 3 | 1 | 1 | 1 |
| 1 | 3 | 1 | 1 | 3 |
| 2 | 3 | 1 | 2 | 3 |
| 3 | 3 | 1 | 2 | 2 |
| 4 | 3 | 3 | 2 | 2 |
| 5 | 3 | 3 | 2 | 1 |
| 6 | 3 | 3 | 3 | 1 |
| 7 | 3 | 3 | 3 | 3 |
| 8 | 1 | 3 | 3 | 3 |
| 9 | 1 | 3 | 3 | 2 |
| 10 | 1 | 3 | 1 | 2 |
| 11 | 1 | 3 | 1 | 1 |
| 12 | 1 | 2 | 1 | 1 |
| 13 | 1 | 2 | 1 | 3 |
| 14 | 1 | 2 | 2 | 3 |
| 15 | 1 | 2 | 2 | 2 |
| 16 | 2 | 2 | 2 | 2 |
| 17 | 2 | 2 | 2 | 1 |
| 18 | 2 | 2 | 3 | 1 |
| 19 | 2 | 2 | 3 | 3 |
| 20 | 2 | 1 | 3 | 3 |
| 21 | 2 | 1 | 3 | 2 |
| 22 | 2 | 1 | 1 | 2 |
| 23 | 2 | 1 | 1 | 1 |

Different from the Layers 5 and 6 of FIG. 5, this upper layer closes the sequence, making it a circular, but at the same time a closed code. In this case, the precision may be increased by adding more layers at the bottom of the structure. This type of circular encoding is useful in many cases where periodicity is required.

For any number of layers NL≥2, the number of QIs of the circular code can be obtained using the equation 3.

NQI(NL)=3×2^{(NL-1)}, NL≥2 [Math. 3]

This circular sequence can be generated using different procedures. An algorithm to do it can be the following: given a temporal sequence of periodicity T or an analog signal of amplitude T, divide the interval T in three equal intervals of length T/3 and encode each of these intervals differently using a ternary code. In the following lower layer, for each of the three QIs obtained in the first step, find a fragmentation point that subdivides each one in two equal parts. These three fragmentation points are shown in Layer 3 of FIG. 7. Then encode each of these intervals with the defined ternary encoding. Continue this procedure until a pre-required definition is achieved.

The above defined encoding can also be implemented using circular encoders, as shown in FIG. 8, which illustrates a generation of a circular Gray code using circular encoders, wherein the dashed lines represent the initial phase.

### Numerical Encoding for Two-dimensional Spaces

Finally, in this section a method is defined that enables the numerical encoding for two-dimensional spaces.

In the preferred embodiments according to the present invention, the step a), which regards the spatial indexing of a two-dimensional space by using Grid Cells, is executed by means of a first stage, which comprises generating a first Gray Code for the indexing of one-dimensional spaces, and a second stage, which comprises generating a second Gray Code for the indexing of two-dimensional spaces through an equilateral triangle, wherein an edge of said equilateral triangle comprises the first Gray Code, generated in the first stage. In the more preferred embodiments of the invention, the first Gray Code is configured for the indexing of circular sequences. In other preferred embodiments, the encoding of the first Gray Code comprises a first stage including the incorporation of a circular encoding and a second stage including the transformation of the circular encoding into a non-circular encoding. In other preferred embodiments, each edge of said equilateral triangles comprises a first Gray Code, preferably including a circular encoding. In the preferred embodiments according to the invention, the first Gray Code and the second Gray Code have a Hamming distance of one, and any respective two neighbor codes differ in one bit position.

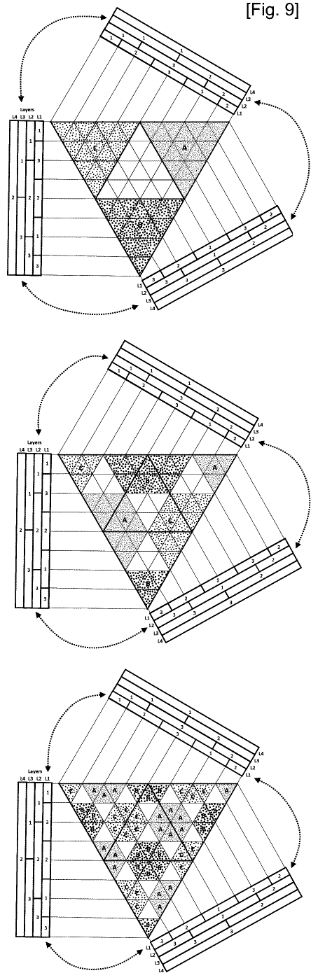

Given the Gray encoding of the three axes obtained in last section we now proceed to define a method that enables the implementation of the two-dimensional encoding shown in FIG. 2. The proposed method allows the generation of the Grid Cells' encoding for two-dimensional spaces, using a set of three circular encoders, as the ones defined in the last section. FIG. 9 illustrates the process used to generate the three layers of encoding. As can be verified, the 1D encoding is applied circularly to the three axes of the equilateral triangle.

From these axes, three Grid Cells are defined: A, B and C, as shown in FIG. 8. The encoding of each of these Grid Cells “A”, “B” or “C” results from the overlap of axial codes with values of “1”, “2” or “3”. The triangles encoded with an “A” results from the overlap of the axial encodings (1, 3, 1), (2, 1, 2) and (3, 2, 3). The triangle encoded with a “B” results from the overlap of the axial encodings (3, 1, 1), (1, 2, 2) and (2, 3, 3). The triangle encoded with a “C” results from the overlap of the axial encodings (1, 1, 3), (2, 2, 1) and (3, 3, 2). All the other triangles are encoded as “0” or NULL.

The algorithm that enables the encoding of the Grids Cells is presented in the next section.

### Implementations and Tests

In this section, we describe an implementation of the encoding shown in FIG. 9, and the tests that were made to verify if the algorithm for the generation of Grid Cells works as expected, when using a robot. In the following, before presenting the obtained results, we start by describing the algorithm that was considered, then the platform and environment used for the tests, the characteristics of the robot and the mechanism used to control its movements.

### Alqorithm for the Generation of Grid Cells

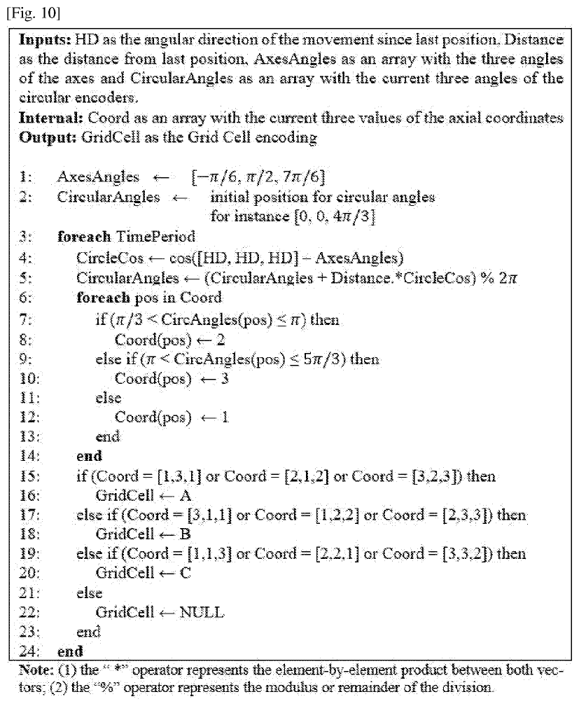

Algorithm 1, illustrated in FIG. 10, contains the pseudocode that was used to generate the grid pattern shown in FIG. 9. Given two locations, the current and the last known positions, the algorithm uses as inputs the angular direction between these two points (represented in radians) and the associated distance. Using a cosine operation, these values are then decomposed in three individual contributions for the three axes, which are separated by 2π/3 angles. These contributions then make the circular encoders rotate according to the associated amplitude and direction. Finally, the encoding of the Grid Cells result from the encodings of the three axes, as described above. All the remaining encodings are defined as NULL.

The pseudocode shown in Algorithm 1, only encodes one layer. The encoding of the other layers requires adjusting the ratio between the distance traveled and the circular encoding as shown in FIG. 6 and FIG. 8.

### Testing Platform

The proposed algorithm was tested using a robot simulator software called Webots (Michel, 2015). This software was created by Cyberbotics and allows the creation of multiple environments with multiple obstacles. Robots can be programed in multiple programing languages like Python, MATLAB, C, Java, and ROS. The Webots converts the code from the programing languages into a binary code that is interpreted by the system. When the simulation starts, the robot executes the previous generated code. The software allows the usage of multiple sensors and accessories. It is also possible to add multiple obstacles and objects making this simulator suitable for testing autonomous vehicles applications.

### Test Conditions

For the set of tests of the algorithm, an environment was created that consists in a squared box with a 2 meters side. The frontiers of the environment are delimited by walls, and the robots can move to any location inside the restricted space

The platform allows using multiple robots. The robot that was chosen was a variant of the Khepera IV (Cyberbotics, n.d.). The Khepera IV robot, developed by K-Team (Cyberbotics, n.d.), has several sensors including an accelerometer, a gyroscope, four Infrared sensors (left, right, rear and ground), two ultrasonic sensors (left and right), a camera. It also has three LEDs (left, right and rear) and a speaker. The variant used also includes a magnetometer that was used to estimate of a head direction, or the angular direction of the movement.

Therefore, in the preferred embodiments according to the present invention, the robot location system comprises a location sensor positioned on the autonomous robot, wherein said location sensor is selected from at least one of the group consisting of an accelerometer, a gyroscope, a infrared sensor, a digital camera and a magnetometer.

In the preferred embodiments of the robot location system, its computational processor is configured to execute the step a) by means of a first stage, which comprises generating a first Gray Code for the indexing of one-dimensional spaces, and a second stage, which comprises generating a second Gray Code for the indexing of two-dimensional spaces through an equilateral triangle, wherein an edge of said equilateral triangle comprises the first Gray Code, generated in the first stage. In the more preferred embodiments of the robot location system, the first Gray Code is encoded by means of a circular encoding, and more preferably, the computational processor is configured to execute the step a) by encoding the first Gray Code with a first stage including a circular encoding. In other preferred embodiment, the said computational processor is configured to execute the step a) by encoding each edge of said equilateral triangles with a first Gray Code. In other preferred embodiment, the said computational processor is configured to execute the step a) by encoding each edge of said equilateral triangles with a first Gray Code including a circular encoding.

In other preferred embodiments of the robot location system, its computational processor is configured to execute the step c) by keeping three vertices and creating three new vertices inside any equilateral triangle of a certain layer L, and by encoding each vertex with a different second ternary code.

In other preferred embodiments of the robot location system, its computational processor is configured to execute the step e) from a lower layer Lᵢ₋₁ to a higher layer L.

The robot controller was programed using the Python programming language. The robot can move freely throughout the squared area. The algorithm used to compute the Grid Cells do not cause any interference in the algorithm used for path selection of the robot. To keep the robot running inside the environment a set of distance sensors were activated. When a wall is detected the robot stops its forward movement and starts rotating over itself to the left until it detected free space.

### Simulation Results

FIG. 11 shows the obtained results for three layers of Grid Cells in the webots environment, wherein: a) without Head Direction error (upper images) and b) with a ±3.5% error in the Head Direction (bottom images). In FIG. 11, the rectangular coordinates x and y were obtained directly from the Webots internal coordinate system, multiplying the robot's current speed by the cosine and sine functions of the Head Direction. Within each of these layers, the A, B, and C areas represent the three distinct Grid Cells. The white area represents the NULL or zero encoded area.

By observing the set of plots in FIG. 11 upper side images, it can be verified that the hexagonal shape of the Grid Cells is well delimited. The method used do not cause any drift between adjacent grids. Each point in the environment receives a unique encoding.

The bottom images of FIG. 11 were obtained using the same algorithm but forcing an ±3.5% error in the readings obtained from the magnetometer. The error was generated using a uniform distribution. As can be verified the error in the magnetometer causes the grid structure and hexagonal shapes to become less well defined. Grid cells become rounder. Besides that, the error does not compromise the structure, neither within each of the layers, nor between distinct layers. The three axial triangular structure tends to compensate the magnetometer errors, that do not accumulate, nor cause persistent drifts.

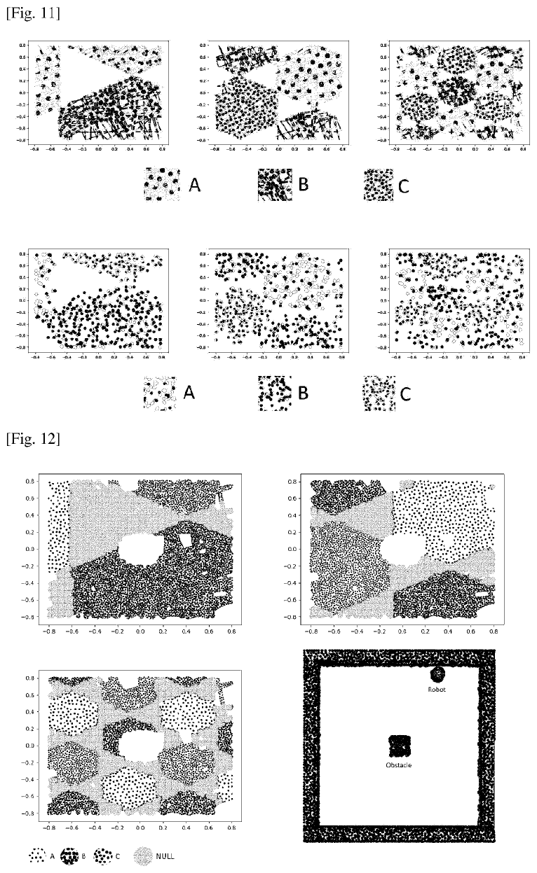

The proposed algorithm is also suitable for mapping environments with obstacles. By inserting an obstacle in the middle of the space, the area around the obstacle is correctly mapped by the robot, as shown in FIG. 12. The white square in the center of this image corresponds to the obstacle, as the robot did not circulate in the associated area. The same behavior is replicated into the different layers.

In the present invention, a Gray encoding was created for both one- and two-dimensional spaces, that is grounded in the developments made in discrete global grid systems and the observations of Grid Cells observed in neuroscience, in the brains of animals.

The triangular coordinate method according to the present invention, was based on the four-fold subdivision of an equilateral triangle proposed in discrete global grid systems, that allows the formation of a grid pattern of tessellating equilateral triangles. These systems are here extended, using a ternary encoding, that around any given symbol, forms hexagonal structures similar with the ones observed in the Grid Cells of the entorhinal cortex. The multilayer structure that results from this process can be recurrently repeated, and thus is rep-tiled.

The grid structure that is defined by the space filling step, allows the encoding of any point of spatial locations, either using ternary or quaternary symbols. By adjusting the number of layers, the process can be recurrently repeated to cover large areas with any target definition. The resulting Gray Code responds to the requirements for the spatial encoding, since (1) it allows that two adjacent locations have a high degree of similarity, (2) it is immune to transition errors when moving between adjacent locations, and (3) allows the logical aggregation of neighbor locations to enable the spatial indexing of assets and objects that might span over several spatial units. We hypothesize that in the hippocampus, these aggregations might be performed in the CA areas that receive the projections of the Grid Cells, leading to what is known as Place Cells.

The two Gray encodings defined for one-dimensional maps, allow the encoding of any periodic (circular) or non-periodic (non-circular) signal, using a set of layers that support any predefined quantization precision. These encodings can be generated using a set of circular encoders. We hypothesize that the bulb-like structure pyramidal neurons organized in a periodic and/or hexagonal pattern, with a bulb-like or tent-like structure can be used to generate an encoding similar with the one here proposed, which then lead to the encoding of Grid Cells.

The method and algorithms defined for the encoding for two-dimensional spaces allows the generation of the hexagonal Grid Cell structure for 2D spaces as defined in the section referred to the encoding of spatial locations. The results of the tests, using a robot simulator, show that the structure does not lead to drift errors, even when ±3.5% errors in magnetometer are forced. These errors cause a blurring in the definition of Grid Cells, leading to a structure similar with the one observed in the tests performed with animals. These errors are compensated by the triangularization and the use of the three axes, avoiding constant drifts in the location of the robot.

The Grid Cells were successfully created without the usage of complex mechanisms like the Oscillatory Interference Model or the Ring Attractor Network. As mentioned in section referred to the computational representations of Grid Cells, those models require complex mathematical operations and neural networks to achieve the same functionality. With the method according to the present invention, it is possible to achieve similar results with a lower amount of inputs and mathematical operations. The direction of movement and the velocity are the key elements essential to map entire environments by using a multilayer system. The proposed encoding method can be used with different types of data and can represent the same information in a ternary way. Such feature allows the representation of different types of data into a triangular coordinate system and the proposed method, namely the steps regarding the triangular coordinate system, are useful in other types of applications.

As used in this description, the expressions “around” and “approximately” refer to intervals of values of more or less 10% of the specified number.

As used in this description, the expression “substantially” means that the real value is within around 10% of the desired value, variable or related limit, particularly within around 5% of the desired value, variable or related limit or particularly within around 1% of the desired value, variable or related limit.

The object-matter described above is provided as an illustration of the present invention and must not be interpreted so as to limit it. The terminology used with the purpose of describing specific embodiments, according to the present invention, must not be interpreted to limit the invention. As used in the description, the definite and indefinite articles, in their singular form, aim at the interpretation with the inclusion of the plural forms, unless the context of the description specifically indicates the contrary. It will be understood that the expressions “comprise” and “include”, when used in this description, specify the presence of the characteristics, the elements, the components, the steps and the related operations, but do not exclude the possibility of other characteristics, elements, components, steps and operations also being contemplated.

All the alterations, providing that they do not modify the essential characteristics of the following claims, must be considered within the scope of protection of the present invention.

### Non Patent Literature

NPL1: Bondarukl, B., Roberts, S., & Robertson, C. (2019). Discrete Global Grid Systems: Operational Capability of the Current State of the Art. Spatial Knowledge and Information Canada

NPL2: Brun, V. H., Solstad, T., Kjelstrup, K. B., Fyhn, M., Witter, M. P., Moser, E. I., & Moser, M.-B. (2008). Progressive increase in grid scale from dorsal to ventral medial entorhinal cortex. Hippocampus, 18(12), 1200-1212. https://doi.org/10.1002/hipo.20504

NPL3: Burgess, N., Barry, C., & O'Keefe, J. (2007). An oscillatory interference model of grid cell firing. Hippocampus, 17(9), 801-812. https://doi.org/10.1002/hipo.20327

NPL4: Bush, I. (Riscaware L. (2017). OpenEAGGR: Software Design Document

NPL5: Cherubini, E., & Miles, R. (2015). The CA3 region of the hippocampus: how is it? What is it for? How does it do it? Frontiers in Cellular Neuroscience, 9. https://doi.org/10.3389/fncel.2015.00019

NPL6: Cyberbotics. (n.d.). K-Team's Khepera IV. Webots User Guide

NPL7: de Almeida, L., Idiart, M., & Lisman, J. E. (2009). The Input-Output Transformation of the Hippocampal Granule Cells: From Grid Cells to Place Fields. Journal of Neuroscience, 29(23), 7504-7512. https://doi.org/10.1523/JNEUROSCI.6048-08.2009

NPL8: de Oliveira, H. M., & Santos-Magalhaes, N. S. (2004). The Genetic Code Revisited: Inner-to-Outer Map, 2D-Gray Map, and World-Map Genetic Representations (pp. 526-531). https://doi.org/10.1007/978-3-540-27824-5_71

NPL9: Dean H. Symonds. (1990). POSITION ENCODER UTILIZERSPECIAL GRAY CODE

NPL10: Eichenbaum, H. (2000). A cortical-hippocampal system for declarative memory. Nature Reviews Neuroscience, 1(1), 41-50. https://doi.org/10.1038/35036213

NPL11: Eliasmith, C., & Anderson, C. H. (2003). Neural Engineering: Computation, Representation, and Dynamics in Neurobiological Systems. Cambridge, MA: MIT Press

NPL12: Esteves, J. S., Carvalho, A., & Couto, C. (2003). Generalized geometric triangulation algorithm for mobile robot absolute self-localization. IEEE International Symposium on Industrial Electronics, I, 346-351. https://doi.org/10.1109/ISIE.2003.1267272

NPL13: Farovik, A., Dupont, L. M., & Eichenbaum, H. (2010). Distinct roles for dorsal CA3 and CA1 in memory for sequential nonspatial events. Learning and Memory. https://doi.org/10.1101/lm.1616209

NPL14: Fuhs, M. C. (2006). A Spin Glass Model of Path Integration in Rat Medial Entorhinal Cortex. Journal of Neuroscience, 26(16), 4266-4276. https://doi.org/10.1523/JNEUROSCI.4353-05.2006

NPL15: Fukawa, A., Aizawa, T., Yamakawa, H., & Eguchi Yairi, I. (2020). Identifying Core Regions for Path Integration on Medial Entorhinal Cortex of Hippocampal Formation. Brain Sciences, 10(1), 28. https://doi.org/10.3390/brainsci10010028

NPL16: Giocomo, L. M., Moser, M. B., & Moser, E. I. (2011). Computational models of grid cells. In Neuron. https://doi.org/10.1016/j.neuron.2011.07.023

NPL17: Global Navigation Satellite Systems: Signal, Theory and Applications. (2012). In S. Jin (Ed.), Global Navigation Satellite Systems: Signal, Theory and Applications. InTech. https://doi.org/10.5772/1134

NPL18: Goodchild, M. F., & Kimerling, A. J. (2002). Discrete Global Grids: A Web Book. In UC—Santa UC Santa Barbara Barbara

NPL19: Guanella, A., Kiper, D., & Verschure, P. (2007). A model of grid cells based on a twisted torus topology. International Journal of Neural Systems, 17(4), 231-240. https://doi.org/10.1142/S0129065707001093

NPL20: Gupta, P., & Cohen, N. J. (2002). Theoretical and computational analysis of skill learning, repetition priming, and procedural memory. Psychological Review, 109(2), 401-448. https://doi.org/10.1037/0033-295X.109.2.401

NPL21: Hafting, T., Fyhn, M., Bonnevie, T., Moser, M. B., & Moser, E. I. (2008). Hippocampus-independent phase precession in entorhinal grid cells. Nature, 453(7199), 1248-1252. https://doi.org/10.1038/nature06957

NPL22: Hafting, T., Fyhn, M., Molden, S., Moser, M. B., & Moser, E. I. (2005). Microstructure of a spatial map in the entorhinal cortex. Nature. https://doi.org/10.1038/nature03721

NPL23: Hales, T. C. (2001). The Honeycomb Conjecture. Discrete & Computational Geometry, 25(1), 1-22. https://doi.org/10.1007/s004540010071

NPL24: Hargreaves, E. L., Rao, G., Lee, I., & Knierim, J. J. (2005). Neuroscience: Major dissociation between medial and lateral entorhinal input to dorsal hippocampus. Science, 308(5729), 1792-1794. https://doi.org/10.1126/science.1110449

NPL25: Kealy, J., & Commins, S. (2011). The rat perirhinal cortex: A review of anatomy, physiology, plasticity, and function. Progress in Neurobiology, 93(4), 522-548. https://doi.org/10.1016/j.pneurobio.2011.03.002

NPL26: Kitamura, T., Pignatelli, M., Suh, J., Kohara, K., Yoshiki, A., Abe, K., & Tonegawa, S. (2014). Island Cells Control Temporal Association Memory. Science, 343(6173), 896-901. https://doi.org/10.1126/science.1244634

NPL27: Kraus, B. J., Brandon, M. P., Robinson, R. J., Connerney, M. A., Hasselmo, M. E., & Eichenbaum, H. (2015). During Running in Place, Grid Cells Integrate Elapsed Time and Distance Run. Neuron, 88(3), 578-589. https://doi.org/10.1016/j.neuron.2015.09.031

NPL28: Kropff, E., Carmichael, J. E., Moser, M. B., & Moser, E. I. (2015). Speed cells in the medial entorhinal cortex. Nature. https://doi.org/10.1038/nature14622

NPL29: Kropff, E., & Treves, A. (2008). The emergence of grid cells: Intelligent design or just adaptation? Hippocampus, 18(12), 1256-1269. https://doi.org/10.1002/hipo.20520

NPL30: Lever, C., Burton, S., Jeewajee, A., O'Keefe, J., & Burgess, N. (2009). Boundary vector cells in the subiculum of the hippocampal formation. Journal of Neuroscience, 29(31), 9771-9777. https://doi.org/10.1523/JNEUROSCI.1319-09.2009

NPL31: Li, X. (2013). Storage and addressing scheme for practical hexagonal image processing. Journal of Electronic Imaging, 22(1), 010502. https://doi.org/10.1117/1.JEI.22.1.010502

NPL32: López Ruiz, J. R., Osuna Carrasco, L. P., López Valenzuela, C. L., Franco Rodríguez, N. E., de la Torre Valdovinos, B., Jiménez Estrada, I., Dueñas Jimenez, J. M., & Dueñas Jiménez, S. H. (2015). The hippocampus participates in the control of locomotion speed. Neuroscience. https://doi.org/10.1016/j.neuroscience.2015.10.034

NPL33: Mandavi-Amiri, Ali; Alderson, Troy; Samavati, F. (2016). Data Management Possibilities for Aperture 3 Hexagonal Discrete Global Grid Systems

NPL34: Malik, Y., Abdul Khaliq, K., Abdulrazak, B., & Tariq, U. (2011). Mobile Node Localization in Cellular Networks. International Journal of Wireless & Mobile Networks, 3(6), 91-100. https://doi.org/10.5121/ijwmn.2011.3607

NPL35: McNaughton, B. L., Battaglia, F. P., Jensen, O., Moser, E. I., & Moser, M.-B. (2006). Path integration and the neural basis of the “cognitive map.” Nature Reviews Neuroscience, 7(8), 663-678. https://doi.org/10.1038/nrn1932

NPL36: Michel, O. (2015). Webots robot simulator. In https://www.cyberbotics.com. https://doi.org/Webots robot simulator

NPL37: Milford, M. J., Wyeth, G. F., & Prasser, D. (2004). RatSLAM: a hippocampal model for simultaneous localization and mapping. IEEE International Conference on Robotics and Automation, 2004. Proceedings. ICRA '04. 2004, 403-408 Vol.1. https://doi.org/10.1109/ROBOT.2004.1307183

NPL38: Naumann, R. K., Preston-Ferrer, P., Brecht, M., & Burgalossi, A. (2018). Structural modularity and grid activity in the medial entorhinal cortex. In Journal of Neurophysiology. https://doi.org/10.1152/jn.00574.2017

NPL39: Neugebauer, O. (1955). The Egyptian “decans.” Vistas in Astronomy, 1, 47-51. https://doi.org/10.1016/0083-6656(55)90011-8

NPL40: Noback C R, Strominger N L, Demarest R J, R. D A. (2005). The Human Nervous System: Structure and Function. In Journal of Library and Information Science: Vol. (5)2 (Issue 2). Totowa, NJ: Humana Press

NPL41: O'Mara, S. M., Commins, S., Anderson, M., & Gigg, J. (2001). The subiculum: A review of form, physiology and function. In Progress in Neurobiology. https://doi.org/10.1016/50301-0082(00)00054-X

NPL42: O'Reilly, K. C., Alarcon, J. M., & Ferbinteanu, J. (2014). Relative contributions of CA3 and medial entorhinal cortex to memory in rats. Frontiers in Behavioral Neuroscience, 8. https://doi.org/10.3389/fnbeh.2014.00292

NPL43: Pham, D. M., Premkumar, A. B., & Madhukumar, A. S. (2011). Error detection and correction in communication channels using inverse gray RSNS codes. IEEE Transactions on Communications, 59(4), 975-986. https://doi.org/10.1109/TCOMM.2011.022811.100092

NPL44: Pilly, P. K., & Grossberg, S. (2014). How does the modular organization of entorhinal grid cells develop? Frontiers in Human Neuroscience. https://doi.org/10.3389/fnhum.2014.00337

NPL45: Poulter, S., Hartley, T., & Lever, C. (2018). The Neurobiology of Mammalian Navigation. In Current Biology (Vol. 28, Issue 17, pp. R1023—R1042). https://doi.org/10.1016/j.cub.2018.05.050

NPL46: Ray, S., Naumann, R., Burgalossi, A., Tang, Q., Schmidt, H., & Brecht, M. (2014). Grid-Layout and Theta-Modulation of Layer 2 Pyramidal Neurons in Medial Entorhinal Cortex. Science, 343(6173), 891-896. https://doi.org/10.1126/science.1243028

NPL47: Richey, M. (1992). The Navigational Background to 1492. Journal of Navigation, 45(2), 266-284. https://doi.org/10.1017/S0373463300010778

NPL48: Sahr, K., Gilly, J., Rabinowitz, N., & Ellis, D. (2018). H3: A hexagonal hierarchical geospatial indexing system

NPL49: Taube, J., Muller, R., & Ranck, J. (1990). Head-direction cells recorded from the postsubiculum in freely moving rats. I. Description and quantitative analysis. The Journal of Neuroscience, 10(2), 420-435. https://doi.org/10.1523/JNEUROSCI.10-02-00420.1990

NPL50: Teyler, T. J., & Rudy, J. W. (2007). The hippocampal indexing theory and episodic memory: Updating the index. In Hippocampus. https://doi.org/10.1002/hipo.20350

NPL51: Tulving, E. (2002). Episodic Memory: From Mind to Brain. Annual Review of Psychology, 53(1), 1-25. https://doi.org/10.1146/annurev.psych.53.100901.135114

NPL52: Urdapilleta, E., Si, B., & Treves, A. (2017). Selforganization of modular activity of grid cells. Hippocampus, 27(11), 1204-1213. https://doi.org/10.1002/hipo.22765

NPL53: v. Bohnenberegr. (1818). Beschreibung einer Maschine, welche die Gesetze der Umdrehung der Erde um ihre Axe, and der Veränderung der Lage der Erdaxe zu erläutern dient. Annalen Der Physik, 60(9), 60-71. https://doi.org/10.1002/andp.18180600907

NPL54: Wrigley, W., & Hollister, W. M. (1965). The Gyroscope: Theory and Application. Science, 149(3685), 713-721. https://doi.org/10.1126/science.149.3685.713

NPL55: Yu, F., Shang, J., Hu, Y., & Milford, M. (2019). NeuroSLAM: a brain-inspired SLAM system for 3D environments. Biological Cybernetics, 113(5-6), 515-545. https://doi.org/10.1007/s00422-019-00806-9

NPL56: Zhu, Y., Gao, H., Tong, L., Li, Z. L., Wang, L., Zhang, C., Yang, Q., & Yan, B. (2019). Emotion regulation of hippocampus using real-time fMRI neurofeedback in healthy human. Frontiers in Human Neuroscience, 13. https://doi.org/10.3389/fnhum.2019.00242

1. A computer implemented method for the indexing of two-dimensional spaces, characterized by comprising the following steps:
a) Spatial indexing of a two-dimensional space by using Grid Cells,
wherein the spatial indexing is based in a triangular coordinate system based in equilateral triangles;
b) Association of the three vertices of at least one equilateral triangle of the triangular coordinate system with a first ternary code;
c) Subdivision of at least one equilateral triangle obtained in the step b) forming a plurality of layers L,
wherein each edge of said equilateral triangle is bisected forming four sub-triangles incorporated within the said equilateral triangle, and
at least one node of the formed sub-triangle is encoded with a second ternary code, and
where the subdivision of an equilateral triangle of a layer Li occurs, four lower level sub-triangles of a layer Li−1 are created, and
wherein the step c) is repeated recursively, wherein i, starting at 0, specifies a subdivision index;
d) Space filling of an area within at least one equilateral triangle or at least one sub-triangle obtained in the step c) by means of an encoding by at least one element selected from the group consisting of a quaternary code, a third ternary code or a binary variable;
e) Generation of a hexagonal coordinate system based on a grid of equilateral triangles and their respective subdivided triangles for two-dimensional spaces.

2. The computer implemented method for the indexing of two-dimensional spaces, according to claim 1, wherein the step a) is executed by means of a first stage, which comprises generating a first Gray Code for the indexing of one-dimensional spaces, and a second stage, which comprises generating a second Gray Code for the indexing of two-dimensional spaces through an equilateral triangle, wherein an edge of said equilateral triangle comprises the first Gray Code, generated in the first stage.

3. The computer implemented method for the indexing of two-dimensional spaces, according to claim 2, wherein the first Gray Code and the second Gray Code have a Hamming distance of one, and any respective two neighbor codes differ in one bit position.

4. The computer implemented method for the indexing of two-dimensional spaces, according to of claim 2, wherein the first Gray Code is configured for the indexing of circular sequences.

5. The computer implemented method for the indexing of two-dimensional spaces, according to claim 4, wherein the encoding of the first Gray Code comprises a first stage including the incorporation of a circular encoding and a second stage including the transformation of the circular encoding into a non-circular encoding.

6. The computer implemented method for the indexing of two-dimensional spaces, according to claim 2, wherein each edge of said equilateral triangles comprises a first Gray Code including a circular encoding.

7. The computer implemented method for the indexing of two-dimensional spaces, according to claim 1, wherein in the step c) inside any equilateral triangle of a certain layer L, three vertices are kept, and three new vertices are created, and each vertex is encoded with a different second ternary code.

8. The computer implemented method for the indexing of two-dimensional spaces, according to claim 1, wherein the step e) is executed from a lower layer Lᵢ₋₁ to a higher layer Lᵢ.

9. The computer implemented method for the indexing of two-dimensional spaces, according to claim 1, wherein in the step e) a ternary code of a node of a hexagon is different from a ternary code of a direct neighbor node.

10. A robot location system, which is configured to map a deployment area, comprising:
a computational processor, wherein the said computational processor is configured to receive an input information about a head direction or an angular direction of an autonomous robot; and
a computational memory, which is configured to store values generated by the said computational processor, wherein the said computational processor is configured to execute the following steps:
a) Spatial indexing of a two-dimensional space by using Grid Cells,
wherein the spatial indexing is based in a triangular coordinate system based in equilateral triangles;
b) Association of the three vertices of at least one equilateral triangle of the triangular coordinate system with a first ternary code;
c) Subdivision of at least one equilateral triangle obtained in the step b) forming a plurality of layers L,
wherein each edge of said equilateral triangle is bisected forming four sub-triangles incorporated within the said equilateral triangle, and
at least one node of the formed sub-triangle is encoded with a second ternary code, and
where the subdivision of an equilateral triangle of a layer L occurs, four lower level sub-triangles of a layer Lᵢ₋₁ are created, and
wherein the step c) is repeated recursively, wherein i, starting at 0, specifies a subdivision index;
d) Space filling of an area within at least one equilateral triangle or at least one sub-triangle obtained in the step c) by means of an encoding by at least one element selected from the group consisting of a quaternary code, a third ternary code or a binary variable;
e) Generation of a hexagonal coordinate system based on a grid of equilateral triangles and their respective subdivided triangles for two-dimensional spaces.

11. The robot location system, according to claim 10, which further comprises a location sensor positioned on the autonomous robot, wherein said location sensor is selected from at least one of the group consisting of an accelerometer, a gyroscope, a infrared sensor, a digital camera and a magnetometer.

12. The robot location system, according to claim 10, wherein the said computational processor is configured to execute the step a) by means of a first stage, which comprises generating a first Gray Code for the indexing of one-dimensional spaces, and a second stage, which comprises generating a second Gray Code for the indexing of two-dimensional spaces through an equilateral triangle, wherein an edge of said equilateral triangle comprises the first Gray Code, generated in the first stage.

13. The robot location system, according to claim 12, wherein the first Gray Code and the second Gray Code have a Hamming distance of one, and any respective two neighbor codes differ in one bit position.

14. The robot location system, according to claim 12, wherein the first Gray Code is encoded by means of a circular encoding.

15. The robot location system, according to claim 12, wherein the said computational processor is configured to execute the step a) by encoding the first Gray Code with a first stage including a circular encoding.

16. The robot location system, according to claim 12, wherein the said computational processor is configured to execute the step a) by encoding each edge of said equilateral triangles with a first Gray Code.

17. The robot location system, according to claim 16, wherein the said computational processor is configured to execute the step a) by encoding each edge of said equilateral triangles with a first Gray Code including a circular encoding.

18. The robot location system, according to claim 10, wherein the said computational processor is configured to execute the step c) by keeping three vertices and creating three new vertices inside any equilateral triangle of a certain layer L, and by encoding each vertex with a different second ternary code.

19. The robot location system, according to claim 10, wherein the said computational processor is configured to execute the step e) from a lower layer Lᵢ₋₁ to a higher layer Lᵢ.

20. The robot location system, according to claim 10, wherein the said computational processor is configured to execute the step e) by providing a ternary code to a node of a hexagon, which is different from a ternary code of a direct neighbor node.

21. A computer program, characterized by comprising instructions which, when the program is executed by a computer, cause the computer to carry out the steps of the method defined in claim 1.

22. A computer-readable data carrier having stored thereon the computer program, as defined in claim 21.
